(19) United States
(12) Patent Application Publication
(10) Pub. No.: US 2015/0046370 A1
(43) Pub. Date: Feb. 12, 2015

(54) PROVIDING PARTICIPANTS WITH MEETING NOTES FOR UPCOMING MEETING

(71) Applicant: Evernote Corporation, Redwood City, CA (US)

(72) Inventors: Phil Libin, San Jose, CA (US); Hemant Garg, Sunnyvale, CA (US); Phil Constantinou, San Francisco, CA (US); Joseph Lopez, Austin, TX (US); Stephen Breen, Allen, TX (US)

(21) Appl. No.: 14/312,941

(22) Filed: Jun. 24, 2014

Related U.S. Application Data
(60) Provisional application No. 61/862,608, filed on Aug. 6, 2013.

(51) Int. Cl. G06Q 10/10

(52) U.S. Cl. CPC G06Q 10/10
USPC 705/345

(57) ABSTRACT

Providing information to a participant of an upcoming meeting includes determining a list of participants of the meeting, determining an agenda of the meeting, analyzing a content collection to determine relevant portions of the collection that relate to the meeting, and providing the relevant portions of the content collection to the participant prior to the meeting. Providing the relevant portions may include causing the relevant portions to be displayed on smart glasses of the participant. Providing the relevant portions may include causing the relevant portions to be sent to a mobile device of the participant. The mobile device may use an operating system selected from the group consisting of: iOS, Android OS, Windows Phone OS, Blackberry OS and mobile versions of Linux OS. The relevant portions of the content collection may be provided automatically to the participant.

### CROSS-REFERENCE TO RELATED APPLICATIONS

This application claims priority to U.S. Prov. App. No. 61/862,608, filed Aug. 6, 2013, and entitled “CALENDAR WITH AUTOMATIC DISPLAY OF RELEVANT NOTES,” which is incorporated by reference herein.

### TECHNICAL FIELD

This application is directed to the field of analyzing, processing and presenting information, and more particularly to the field of creating, delivering and displaying user content associated with scheduled meetings.

### BACKGROUND OF THE INVENTION

Business meetings are an important part of a corporate life. Numerous workflows, hardware solutions, software applications and online services have been developed to facilitate scheduling, preparations, conduct, information exchange and follow-up on business meetings, as well as distribution of accompanying business notes and documents. Still, achieving high productivity and efficiency for business meetings remains a challenging goal. On an average day, there are 17-20 million meetings in America; according to industry and academic research, employees spend 20-40% of their time in meetings, while for upper management this number increases to more than 50% of the work time. However, by various estimates and according to multiple industry surveys, meetings are only 44-50% efficient, while 25% of cumulative meeting time is spent discussing irrelevant issues. In a recent survey of 1300 business leaders from Europe and North America, 25 to 50 percent of respondents questioned the efficiency of existing meeting systems. At the same time, 80% of survey participants identified technology advances as the number one factor for future increase in meeting productivity. In a 2012 work efficiency survey of over 3,200 employees, 47% of participants identified corporate meetings as the single leading time-wasting factor, ahead of more of a dozen of other reasons for work inefficiency suggested by the survey. Overall, inefficiency of corporate meetings causes multi-billion dollar business losses every year. Therefore, improving the efficiency of business meetings remains a major challenge for enterprise and personal productivity.

Experts in time management, team building, a GTD (Getting Things Done) organizational methodology and in other areas of business efficiency improvement are dissecting problems causing meeting inefficiency in different ways. Two factors related to enterprise information management are often highlighted in research papers and rank near the top of the list of causes of time wasting during and between meetings; these factors are (1) insufficient preparedness of meeting organizers, participants and leaders; and (2) improper compilation and distribution of meeting materials. According to one survey on meeting efficiency, two thirds of business meetings don't even have an announced agenda. As a consequence, no relevant materials are distributed to meeting participants who are left guessing about the meeting specifics and remain confused about decisions made at the meetings. The same survey on meeting efficiency indicates that around 63% of repetitive meetings do not have meeting minutes produced for all follow-up meetings. As for instances where meeting minutes are provided, almost 40% of them take over a week to get delivered to the target audience. Therefore, meeting results and follow-up actions also remain unknown to many participants and other involved personnel.

Mobile devices such as smartphones play an increasing role in scheduling and tracking of business meetings. Experts concur that with the arrival of various types of wearable devices, such as smart glasses, smart watches, small flexible displays and other devices, mobilization of calendar applications will continue. In particular, mobile phones with cameras may be helpful in capturing materials created during meetings, such as whiteboard brainstorms, paper notes, annotated pre-printed documents, etc. In addition, other types of devices, such as smart TVs, projection screens and other large format displays, will be able to simultaneously access scheduling and meeting information.

With the proliferation of multi-platform content management systems, such as the Evernote service and software offered by Evernote Corporation of Redwood City, Calif., an increasing percent of meeting related materials may be stored in the cloud and synchronized across multiple devices and individuals. Sharing capabilities of content management systems bring to business meetings a potential for everyone with the need to know to adequately access meeting materials. However, existing calendar and scheduling applications often lack an ability to identify relevant information, associate it with meetings, and choose right groups of participants for delivery of materials. Additionally, existing calendar and scheduling applications may not be capable of delivering and displaying relevant information in a timely manner to different types of devices owned by participants.

Accordingly, it is desirable to develop an adequate workflow between planning and scheduling processes and software applications and content management systems employed by a business, including consistent and timely display of meeting related materials on different types of devices owned by meeting participants.

### SUMMARY OF THE INVENTION

According to the system described herein, providing information to a participant of an upcoming meeting includes determining a list of participants of the meeting, determining an agenda of the meeting, analyzing a content collection to determine relevant portions of the collection that relate to the meeting, and providing the relevant portions of the content collection to the participant prior to the meeting. Providing the relevant portions may include causing the relevant portions to be displayed on smart glasses of the participant. Providing the relevant portions may include causing the relevant portions to be sent to a mobile device of the participant. The mobile device may use an operating system selected from the group consisting of: iOS, Android OS, Windows Phone OS, Blackberry OS and mobile versions of Linux OS. The relevant portions of the content collection may be provided automatically to the participant. The relevant portions of the content collection may be provided automatically at a time around a start time of the upcoming meeting. The relevant portions of the content collection may be provided automatically at a time around a start time of the upcoming meeting if the participant is at a location that is close enough to a location of the meeting to be able to attend the meeting. The relevant portions of the content collection may be provided automatically if the participant had not previously accessed the relevant portions. Analyzing a content collection to determine relevant portions may include determining similarities between the relevant portions and information about the upcoming meeting. Determining similarities may include examining meeting time, location, participants, and context.

According further to the system described herein, gathering information related to a meeting includes confirming that the meeting has occurred, analyzing an item submitted to a content collection to determine if the item relates to the meeting, and, if the item relates to the meeting, adding the item to a cluster of materials associated with the meeting, the cluster of materials being part of the content collection. The item may be a document created during a meeting at a meeting location using at least one of the following: a traditional whiteboard, an electronic whiteboard, an Easel Pad, an IdeaPaint wall, a dry erase surface, a presentation, and materials posted online by meeting participants. The item may include as least one photograph of handwritten materials created during the meeting and added to the content collection. An electronically rendered arrow may be present in a photo preview and manually fixed to a portion of the photograph prior to the photograph being added to the content collection. Moving and then releasing the electronically rendered arrow in the photo preview may cause the photograph to be taken. Analyzing an item may include determining similarities between the item and the meeting. Similarities may be based on the item strongly correlates with content filed during the meeting, titles in the item are directly mentioned in an action list from the meeting, titles in the item are directly mentioned in a to-do list from the meeting, and/or the item includes at least one direct reference to the meeting. The direct reference may be a reference to a meeting time and/or meeting location. Confirming that the meeting has occurred may include confirming that an organizer of the meeting and at least one other scheduled participant are attending the meeting. Location information provided by mobile devices may be used to determine if scheduled participants are attending the meeting. The mobile device may use an operating system selected from the group consisting of: iOS, Android OS, Windows Phone OS, Blackberry OS and mobile versions of Linux OS. At least one participant may attend the meeting remotely using conference tools from a location that is remote from a location of the meeting. Items that relate to the meeting as well as items that relate to other previous meetings and items that relate to upcoming meetings may be provided to a smart TV set. A calendar having the meetings and associated ones of the related items may be provided to the smart TV set and a user may scroll through the calendar to see the meetings and the related notes.

According further to the system described herein, computer software, provided in a non-transitory computer-readable medium, provides information to a participant of an upcoming meeting. The software includes executable code that determines a list of participants of the meeting, executable code that determines an agenda of the meeting, executable code that analyzes a content collection to determine relevant portions of the collection that relate to the meeting, and executable code that provides the relevant portions of the content collection to the participant prior to the meeting. Executable code that provides the relevant portions may cause the relevant portions to be displayed on smart glasses of the participant. Executable code that provides the relevant portions may cause the relevant portions to be sent to a mobile device of the participant. The mobile device may use an operating system selected from the group consisting of: iOS, Android OS, Windows Phone OS, Blackberry OS and mobile versions of Linux OS. The relevant portions of the content collection may be provided automatically to the participant. The relevant portions of the content collection may be provided automatically at a time around a start time of the upcoming meeting. The relevant portions of the content collection may be provided automatically at a time around a start time of the upcoming meeting if the participant is at a location that is close enough to a location of the meeting to be able to attend the meeting. The relevant portions of the content collection may be provided automatically if the participant had not previously accessed the relevant portions. Executable code that analyzes a content collection to determine relevant portions may determine similarities between the relevant portions and information about the upcoming meeting. Determining similarities may include examining meeting time, location, participants, and context.

According further to the system described herein, computer software, provided in a non-transitory computer-readable medium, gathers information related to a meeting. The software includes executable code that confirms that the meeting has occurred, executable code that analyzes an item submitted to a content collection to determine if the item relates to the meeting, and executable code that adds the item to a cluster of materials associated with the meeting if the item relates to the meeting, the cluster of materials being part of the content collection. The item may be a document created during a meeting at a meeting location using at least one of the following: a traditional whiteboard, an electronic whiteboard, an Easel Pad, an IdeaPaint wall, a dry erase surface, a presentation, and materials posted online by meeting participants. The item may include as least one photograph of handwritten materials created during the meeting and added to the content collection. An electronically rendered arrow may be present in a photo preview and manually fixed to a portion of the photograph prior to the photograph being added to the content collection. Moving and then releasing the electronically rendered arrow in the photo preview may cause the photograph to be taken. Executable code that analyzes an item may determine similarities between the item and the meeting. Similarities may be based on the item strongly correlates with content filed during the meeting, titles in the item are directly mentioned in an action list from the meeting, titles in the item are directly mentioned in a to-do list from the meeting, and/or the item includes at least one direct reference to the meeting. The direct reference may be a reference to meeting time and/or meeting location. Executable code that confirms that the meeting has occurred may confirm that an organizer of the meeting and at least one other scheduled participant are attending the meeting. Location information provided by mobile devices may be used to determine if scheduled participants are attending the meeting. The mobile device may use an operating system selected from the group consisting of: iOS, Android OS, Windows Phone OS, Blackberry OS and mobile versions of Linux OS. At least one participant may attend the meeting remotely using conference tools from a location that is remote from a location of the meeting. Items that relate to the meeting as well as items that relate to other previous meetings and items that relate to upcoming meetings may be provided to a smart TV set. A calendar having the meetings and associated ones of the related items may be provided to the smart TV set and a user may scroll through the calendar to see the meetings and the related notes.

The proposed system verifies occurrences of scheduled events, including business meetings, automatically creates lists of relevant materials prior to meetings, as well as meeting notes and post-meeting materials, enhances photographs of whiteboard and paper notes taken during meetings with instant hotspot indication and markup, and, depending on timing, location and other factors, delivers relevant materials and meeting notes to various devices used by participants.

Before a meeting or other relevant event has started, the system may associate relevant content (hereinafter, related notes) with the meeting using a list of participants and agenda. A mechanism for associating with business meetings items filed into a business wide content collection, such as documents, photos, scanned images, audio and video clips, typed and handwritten notes, etc. may be based on similarity or distance metrics measured between an available or a newly posted content item, on the one hand, and a calendar item and actual meeting attributes for a scheduled and verified meeting, on the other hand. Parameters for determining such similarity may include time, location, people, and context.

Relevant pre-meeting materials, meeting notes and other appropriate content may be extracted from (and/or added to) content collections shared between groups of people with a need to know or available business wide. Subsequently, all types of materials may be delivered, when available, to a desired audience. Once a list of related notes has been created and entered into a content collection, as explained elsewhere herein, the system may monitor access by meeting participants to the relevant notes.

In one scenario, if a meeting participant has not accessed related notes prior to a meeting, the system may deliver such notes to a mobile device of the participant right before the meeting or even at the start of the meeting, provided the participant is located at or near the meeting place. This may be especially efficient if a participant is using an augmented reality device, such as smart glasses: the participant may be approaching the meeting place shortly before the start of the meeting and may receive meeting information on a built-in display of the augmented reality device.

The system may verify scheduled business meetings. During the meeting time, the system may track each scheduled meeting on smartphones, wearable devices and computers of a meeting organizer and scheduled participants. Accordingly, the system may be able to check whether the meeting organizer is located at the scheduled meeting place and at least one other participant is either located at the same meeting place or is connected via a remote conferencing tool from another location to the conferencing equipment at the meeting place. If these conditions hold, the meeting occurrence may be confirmed for all participants located at the meeting place or connected with the meeting place from remote location(s). Any other invited participant or another individual connected, at the same time, via conferencing tools (e.g., phone, instant messaging, video conferencing, etc.) with some equipment at the meeting place or with any of the confirmed participants may be also regarded as a meeting participant, possibly uninvited on the original participant list.

After the meeting has started, meeting materials may be created. The meeting materials may include individual meeting notes taken by participants, collective brainstorms on traditional or electronic whiteboards and on other writing surfaces such as Easel Pads, IdeaPaint walls or other dry erase surfaces, presentations, materials posted online by meeting participants, etc. Any materials submitted by meeting participants to a shared content collection during the meeting time may be automatically associated with the meeting. Any materials posted into a content collection by others at a scheduled time of the meeting that mention the meeting and possibly some of the meeting participants may also be associated with the meeting.

Smartphones equipped with cameras are becoming increasingly ubiquitous. Other camera equipped mobile devices, such as smart glasses with head-mounted cameras are approaching the market; correspondingly, photographs of whiteboards and paper notebooks captured during and after business meetings are quickly growing in volume. A useful aspect of capturing such meetings materials is an ability to instantly emphasize one or several key points on each snapshot of a whiteboard or a page in a paper notebook. Unlike a paper notebook, which may keep continuous records of meetings of an owner of the notebook, drawings on regular whiteboards are an erasable medium, so users may have to take quick snapshots of whiteboard content and may not have enough time for a comprehensive markup during a meeting.

In order to facilitate defining hotspots on photos, a markup software application, such as Evernote Skitch, may provide a special augmented reality camera mode where a blank unattached pointing arrow may appear on the screen in a camera preview mode prior to taking a snapshot. The user may drag the arrow to a desired position on the scene or click on the hotspot to move the arrow to a point in the scene and cause instant capturing of the snapshot. The arrow will appear in the photo pointing to a portion thereof and having a size, color and other attributes according to current settings of the markup software. In this way, instant hotspots may be added to photos with a minimal distraction of a participant from the meeting flow. Multiple arrows or other markup elements may also be added in the preview mode.

For materials submitted to a shared content collection after the meeting, contextual similarity may play a more significant role. For example, if (i) a content of submitted materials strongly correlates with content filed during the meeting; or if (ii) titles of newly submitted materials are directly mentioned in an action or a to-do list from the meeting; or if (iii) new materials include direct references to the meeting (e.g. meeting title and/or time & location), then additional materials satisfying any or all of the conditions (i)-(iii) may be loosely associated with the meeting. To avoid overloading a cluster of materials related to a business meeting, such associations may be presented to the meeting organizer or to other participants for approval or rejection of the association. Hereinafter, associated meeting materials created during and after the meeting are called meeting notes, analogously to related notes compiled prior to the meeting.

If a content management system used for storing the materials allows links between items of content collections, a cluster of materials related to a meeting may be organized as a unidirectional or a bidirectional list. The cluster may include a calendar (scheduling) note for an event at a top of the hierarchy and an index note (enhanced table of contents) bi-directionally linked to the top note. Each new item (note) added to the cluster via content associations (explained elsewhere herein) adds a new entry into the table of content of the index note; the entry is linked with a newly added note, and, in case of a bidirectional list, the newly added note may also be modified by acquiring a link back to the index note. Such interlinked organization of clusters facilitates browsing of related materials by users.

At any given time, shared content collections may include multiple sets of related and meeting notes associated with different meetings and other scheduled events. Calendar owners may preview one or both note lists available for each calendar event. For example, a scrollable individual or shared calendar may be displayed on a large screen of a smart TV set, transmitted to the TV via a wireless home network. The calendar owner may scroll future and past scheduled events to bring to the screen lists of related notes for future events and lists of related and meeting notes for past events. The owner may use the lists to review past and future meetings, comment, modify materials, plan upcoming daily routines, etc.

### BRIEF DESCRIPTION OF THE DRAWINGS

Embodiments of the system described herein will now be explained in more detail in accordance with the figures of the drawings, which are briefly described as follows.

FIG. 1 is a schematic illustration of compilation of related notes for scheduled events, according to embodiments of the system described herein.

FIG. 2 schematically illustrates displaying related notes on a wearable augmented reality device, according to embodiments of the system described herein.

FIGS. 3A-3D are schematic illustrations of a meeting verification process, according to embodiments of the system described herein.

FIGS. 4A, 4B, and 4C are schematic illustrations of adding an instant hotspot to a whiteboard photograph, according to embodiments of the system described herein.

FIG. 5 is a schematic illustration of creation of meeting notes, according to embodiments of the system described herein.

FIG. 6 is a schematic illustration of scrolling a calendar and viewing related and meeting notes on a smart TV set, according to embodiments of the system described herein.

FIG. 7 is a system flow diagram illustrating processing performed in connection with system activities, according to embodiments of the system described herein.

### DETAILED DESCRIPTION OF VARIOUS EMBODIMENTS

The system described herein provides a mechanism for creation of sets of related and meeting notes associated with a business meeting or other scheduled event. The system provides meeting verification, association of materials posted into shared content collections with the meeting, extraction of relevant notes, interlinked organization of related materials in business-wide content collection, and dynamic distribution of meeting materials to appropriate individuals and groups in different formats and to different devices. The system also enables creation of instant hotspots on photographs of meeting materials.

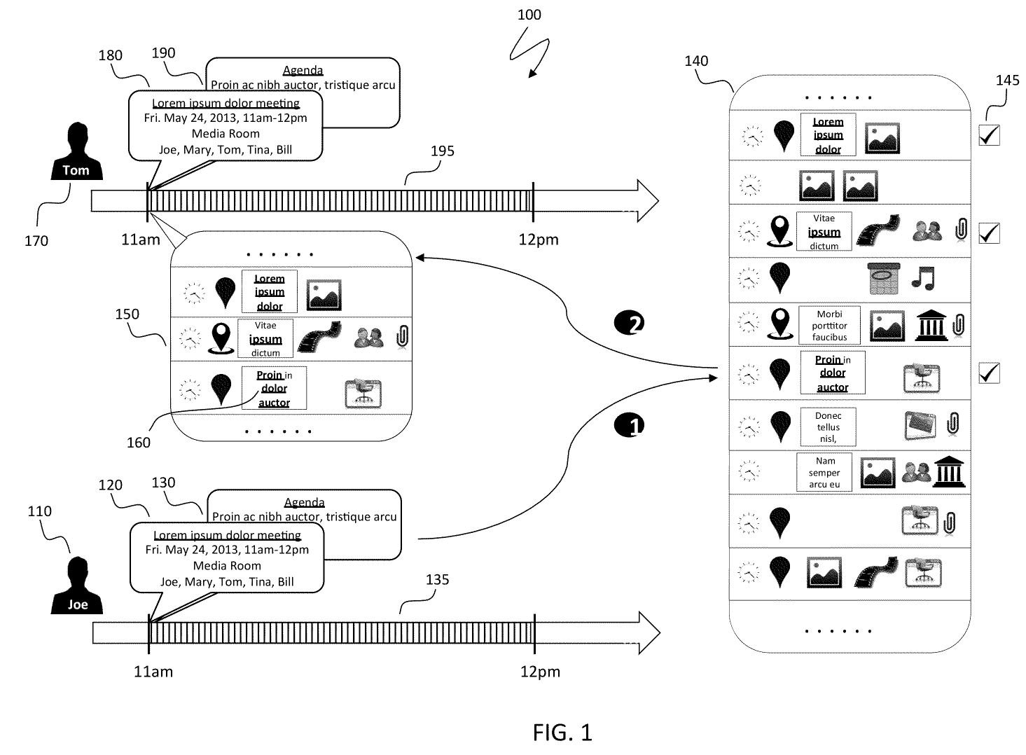

FIG. 1 is a schematic illustration 100 of a compilation of related notes for scheduled events. A meeting organizer 110 (Joe) has a scheduled meeting 120 with an agenda 130 for a time period 135 (11 am-noon). Meeting information, including title, time, location, participants and agenda, are compared, at phase one, with notes in a content collection 140, with the purpose of identifying related notes, as explained elsewhere herein. At phase two, discovered related notes 160 (marked by checkboxes 145 in the content collection 140) may be combined into a set 150 of related notes and may be transferred to other meeting participants, such as a participant 170 (Tom) who has a meeting 180 with an agenda 190 that is the same meeting as the meeting 120 organized by the meeting organizer 110 with a time slot 195 scheduled on a calendar of the participant 170. Obviously, related notes may also be delivered back to the meeting organizer 110. Meeting efficiency is increased by sufficient accuracy of identifying related notes and a timely dynamic delivery of related materials to meeting participants, with due respect to mobile lifestyles of the participants.

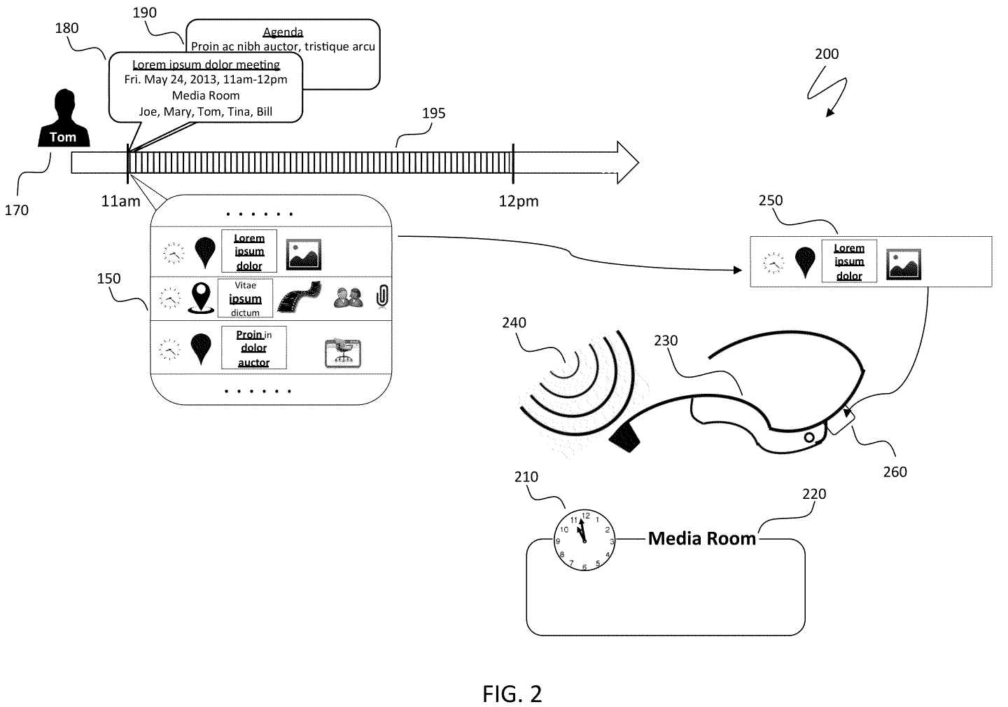

FIG. 2 is a schematic illustration 200 of delivering and displaying related notes on a wearable augmented reality device, such as smart glasses. The list of related notes 150 for a meeting has been compiled from a content collection as explained in connection with FIG. 1. The meeting participant 170 (Tom) has the corresponding meeting 180 with the agenda 190 and the timeframe 195 on a schedule maintained by the participant 170. The system may constantly checks a status of the participant 170, including time, location and awareness of the related notes 150. FIG. 2 illustrates a scenario where the participant 170 is heading to the meeting and finds himself near a meeting place 220, which is indicated in information for the meeting 180 as being a Media Room, at a time that is around the meeting start time (as shown by a clock 210). In such a situation, the meeting participant may be in a need to instantly access related notes 150. There may be various reasons for the participant 170 to view the related notes 150 while travelling to the meeting 180: the participant 170 might have been too busy to view the related notes 150 previously; the participant 170 may have forgotten some important points about the meeting 180; the participant 170 may need to discuss a couple meeting points with another participant before the start of the meeting 180; etc. In any event, the system either knows that the participant 170 has not viewed the related notes 170 previously or determines that a review of the related notes 150 is needed again right before the meeting 180 or the participant 170 requests a review of the related notes 150.

In FIG. 2, the participant 170 is wearing smart glasses 230 when arriving at the meeting 180, which allows transferring and displaying related notes with minimal interruption of workflow and mobility of the participant 170. In the scenario illustrated in FIG. 2, the related notes 150 may be delivered to the smart glasses 230 via a wireless connection 240; subsequently, an individual related note 250 or all of the related notes 150 (with a selectable list) may be shown on a display 260 of the smart glasses 230, allowing the participant 170 to view, scroll and select from the related notes 150.

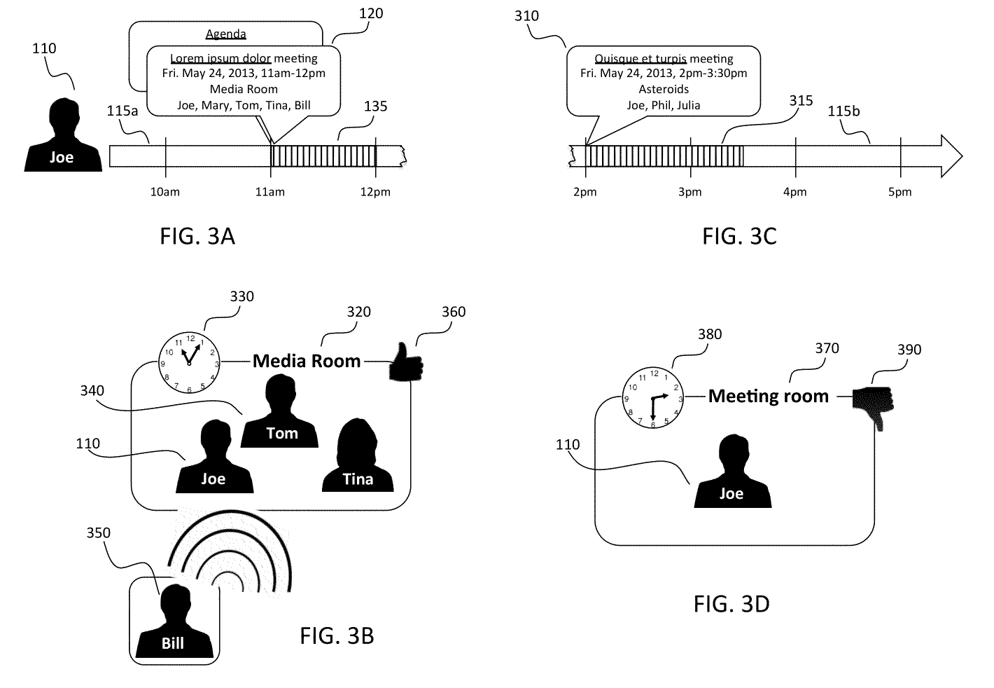

FIGS. 3A-3D are schematic illustrations of a meeting verification process. The meeting organizer 110 has scheduled meetings arranged on portions 115a, 115b of a timeline, which may be visualized in different ways in personal and shared software calendar applications. For illustration purposes, a meeting 120 scheduled for a time period 135 between 11 am-12 pm and a meeting 310 scheduled for a time period 315 between 2 pm and 3:30 pm are both depicted on the portions 115a, 115b of the timeline. Each of the meetings 120, 310 includes a list of participants; in this example, the only attendant at both meetings is the meeting organizer 110 (Joe). A scheduled meeting location 320 for the meeting 120 is a Media Room. Immediately after the start of the meeting 120, the system checks locations of meeting participants using mobile devices of the participants, wearable computers and other mechanisms, provided such checking is possible and permitted. The system compares current participant location(s) with the location 320 of the meeting 120 and makes a meeting validation determination based on user and meeting location data and on additional information about remote participants connected to the meeting room and/or other meeting participants. In FIG. 3B, shortly after the start of the meeting 120, as indicated by a clock 330, the system finds three meeting participants 340 in the meeting room 320, including the meeting organizer 110. Additionally, the system has detected that another original participant 350 of the meeting 120 has been connected with a conferencing equipment of the meeting room 320 or/and with a mobile device of one or more of the meeting participants 340. The combination of physical meeting participants present at the location 320 of the meeting 120 or connected with the location 320 of the meeting 120 is sufficient evidence for the system to validate and confirm the occurrence of the meeting 120, as indicated by an acceptance flag 360. Upon a successful validation of the meeting 120, the system may start compiling a cluster of meeting materials in a shared or company-wide content collection, as explained elsewhere herein.

As shown in FIGS. 3C and 3D, the meeting 310 with three originally scheduled participants is scheduled to occur in a location 370 (Meeting Room). In this case, long after the start of the meeting, as indicated by a clock 380, the system may identify only the presence of the meeting organizer 110 at the location 370. This may lead to two possibilities: either the meeting 310 has not gone as planned or other participants may be present in the conference room but their mobile equipment does not allow identifying precise location (or may be left by the participants outside of the meeting location). Since the system may be continuously tracking the location of other meeting participants close to a time of the start of the meeting 310, the system may be able to determine whether location(s) of other participant(s) have been identifiable. If so, then the absence of participants at the meeting place may be a reason for the system to drop the meeting 310, as shown by a dismissal flag 390. If the location of the other participants is not identifiable, the system may determine a potential uncertainty and send a message to a mobile device of the meeting organizer 110 asking to confirm dismissal of the meeting 310 or declare the meeting 310 occurring with some of the participants of the meeting 310 disconnected from the system. In the latter case, the system may still validate the meeting 310 and start collecting meeting data.

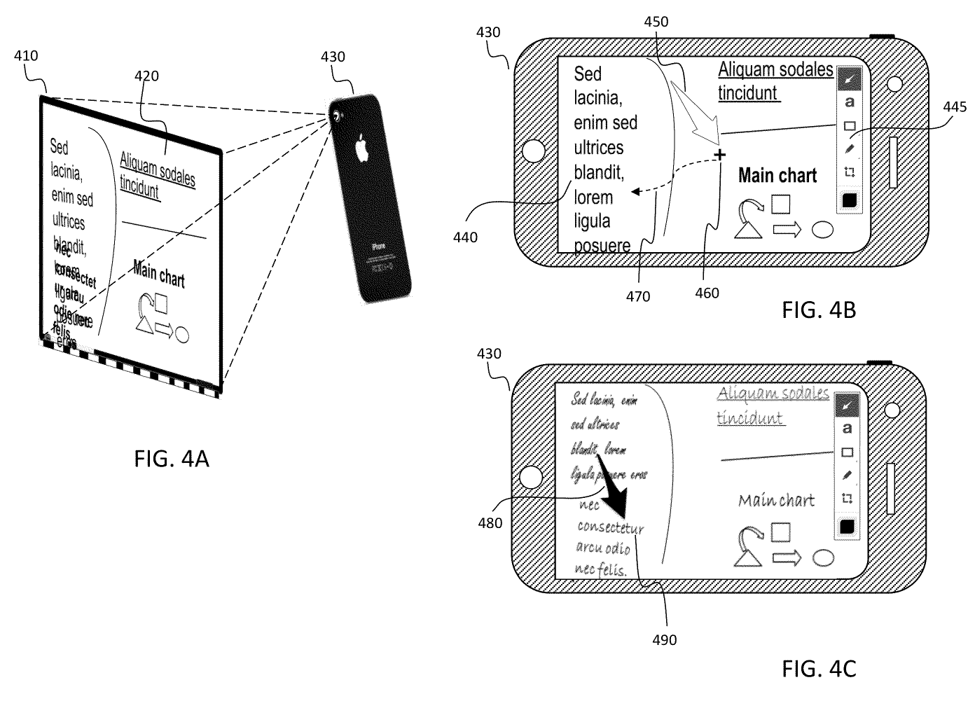

FIGS. 4A, 4B, and 4C are schematic illustrations of adding an instant hotspot to a whiteboard photograph. FIG. 4A shows a traditional whiteboard 410 that may have been used by meeting participants for writing meeting notes 420. The notes 420 are previewed by one of the participants that has a camera phone 430 (or possibly some other type of mobile device with a camera). In FIG. 4B, the phone 430 runs an instant markup application 440 with a toolbar 445 where an electronically rendered markup arrow is selected. The phone 430 shows the content in the preview mode, prior to taking a photograph. The phone 430 shows an unattached blank markup arrow 450 for identifying instant hotspots positioned in the center of a screen 460 of the phone 430. A meeting participant capturing the whiteboard meeting note may instantly drag the arrow 450 from a central starting position on the screen 460 of the phone 430 to a position at a desired hotspot, as shown by an arrow navigation path 470. Alternatively, the participant may tap in the desired position of the screen 460 to indicate a hotspot. Either the release of the arrow 450 after being dragged or a tap on a hotspot may cause the application 440 to take a photograph of the whiteboard content and provide a dark arrow 480 attached to an annotated hotspot 490, as shown in FIG. 4C.

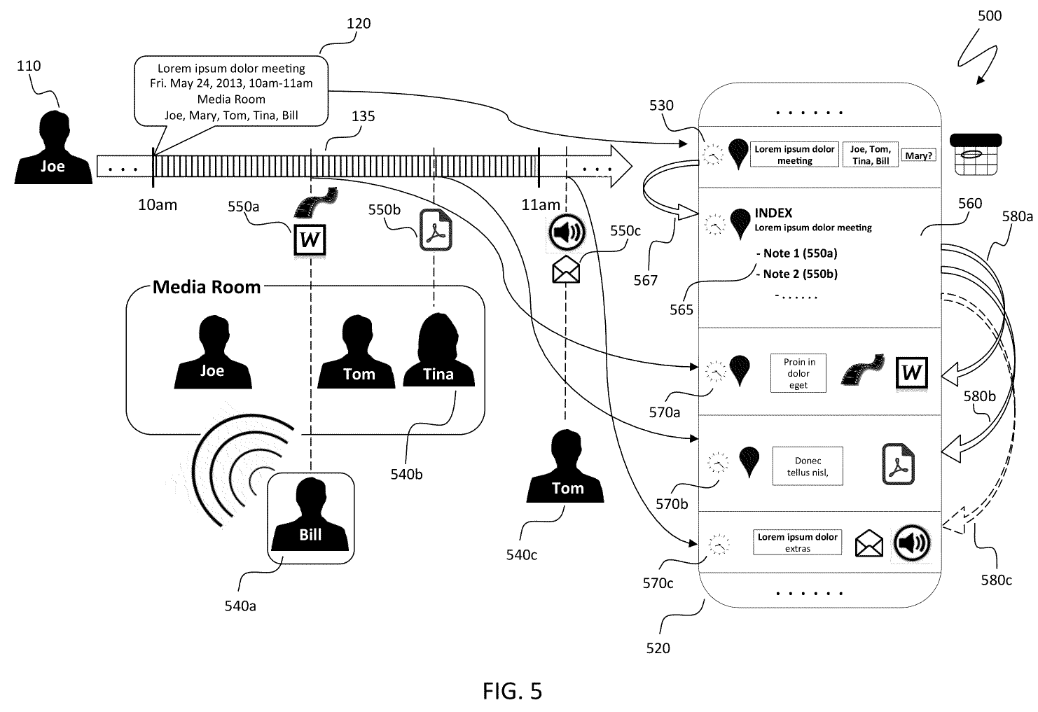

FIG. 5 is a schematic illustration 500 of creation of meeting notes and organization of the meeting notes in a content collection. As discussed elsewhere herein, the meeting organizer 110 conducts the business meeting 120 (introduced and described in FIG. 1), which may include the timeframe 135, agenda, location, original participants, actual participation, related notes built prior to the meeting, etc.

Once the meeting 120 has been confirmed, as explained elsewhere herein (see, for example, FIG. 3 and the corresponding text), the system may create a starting calendar note 530 in a shared content collection 520, as indicated by a calendar icon to the right of the note 530. The note 530 may include meeting time, place, agenda, actual and missing participants and other attributes, as symbolically illustrated by icons and text boxes in the body of the note 530.

Meeting participants may post various materials related to the meeting 120, along with actual notes taken during the meeting, to the same or to other content collection(s). In FIG. 5, a remote participant 540a (Bill) posts a batch of materials 550a during the meeting 120, including a document and a video clip. Similarly, a participant 540b (Tina) of the meeting 120 posts a PDF document 550b, also during the meeting. Following completion of the meeting 120, a meeting participant 540c (Tom) posts additional materials 550c, deemed “extras”, including a summary email and an audio recording of all or a portion of the meeting 120. Each of the posts may be checked by the system for relevance to the meeting 120 using similarity metrics based on time, space, people and context of the posts. For example, materials posted during the business meeting 120 by meeting participants, such as the materials 550a, 550b, may be strongly associated with the meeting and the contextual relevance check of the materials 550a, 550b may be less demanding than in the case of the materials 550c; indeed, although the materials 550c were posted by a (former) physical participant 540c (Tom) of the meeting 120, the materials 550c have arrived after the end of the meeting and could in principle reflect a different project of the participant 540c. In FIG. 5, an assumption is made that all three batches of the materials 550a, 550b and 550c have proven relevant to the meeting 120. This leads to the following organization of meeting materials in the content collection 520.

Immediately after arrival of the materials 550a, the system may begin compiling a cluster of materials associated with the meeting. The system may start with creation of an index note 560, analogous to a table of contents. The index note 560 may include a preamble that indicates an actual time, location and title of the meeting 120. The index note 560 may also include a dynamically created index (TOC) 565, where each new entry corresponds to a latest arriving batch of meeting materials from each participant. After adding each entry, the system may create a new note for storing actual materials and link a TOC entry to the new note. This is illustrated by subsequent entries in the TOC 565 of new notes 570a, 570b, 570c corresponding to the posted materials 550a, 550b, 550c, and by entries of links 580a, 580b, 580c allowing a viewer of the index note 560 to access materials by simply clicking on entries of the TOC 565. Reciprocal links from notes with meeting materials back to the index note may also be present to facilitate fast scanning of meeting materials in a bi-directional cluster; reciprocal links are not shown in FIG. 2. Additionally, after an index note 560 is created, the index note 560 may be connected to the calendar note 530 either in a one-directional way or a bi-directional way.

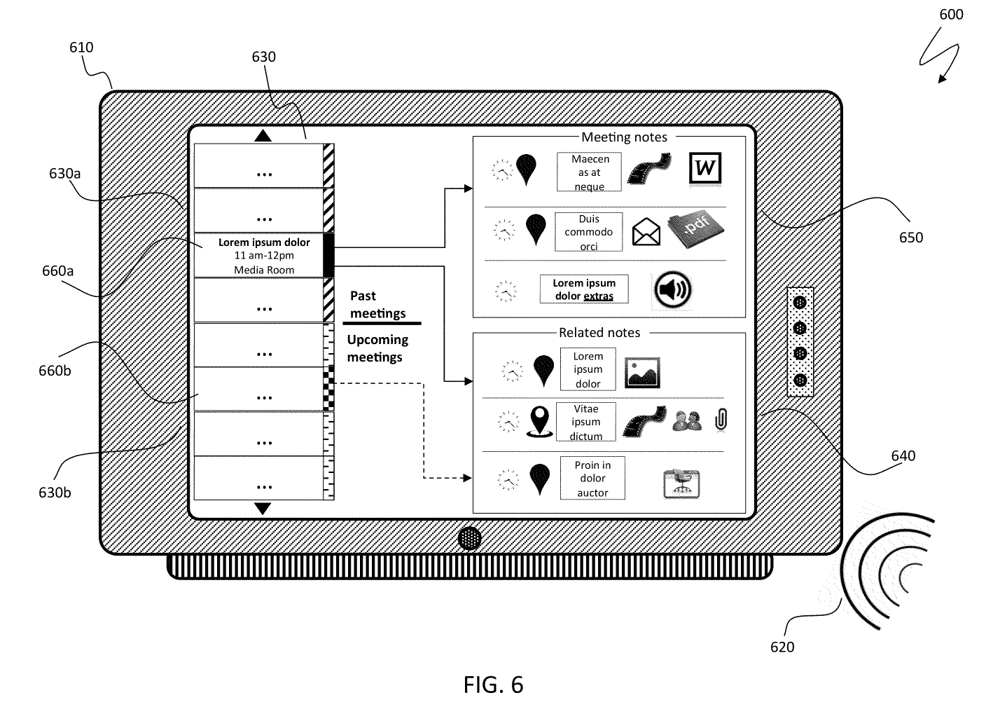

FIG. 6 is a schematic illustration 600 of scrolling a calendar and reviewing related notes and meeting notes on a smart TV set 610. Content may be delivered to the smart TV set 610 using a connection 620, which may be a wireless or a wired connection. The content may include a personal or shared calendar 630, sets of related notes 640 associated with some or all calendar entries, and sets of meeting notes 650 associated with some or all past meetings or other scheduled events in the calendar 630. A user may scroll the calendar 630 so that portions of the calendar 630 containing past meetings 630a, future meetings 630b or both may appear on the screen of the TV set 610. The user may select a calendar entry to view notes related to the calendar entry and, if applicable, also view related meeting notes. For example, selecting a calendar entry corresponding to a past meeting 660a may display both a set of related notes 640 and a set of meeting notes 650, as shown by two solid arrows. Another example shown in FIG. 6 is choosing an upcoming meeting 660b which causes display of related notes connected with the calendar entry 660b with a dashed arrow (meeting notes for upcoming meetings are not available yet). The user may further scroll through lists of the notes 640, 650 and select individual notes from the lists to zoom in on the lists on the screen of the TV set 610.

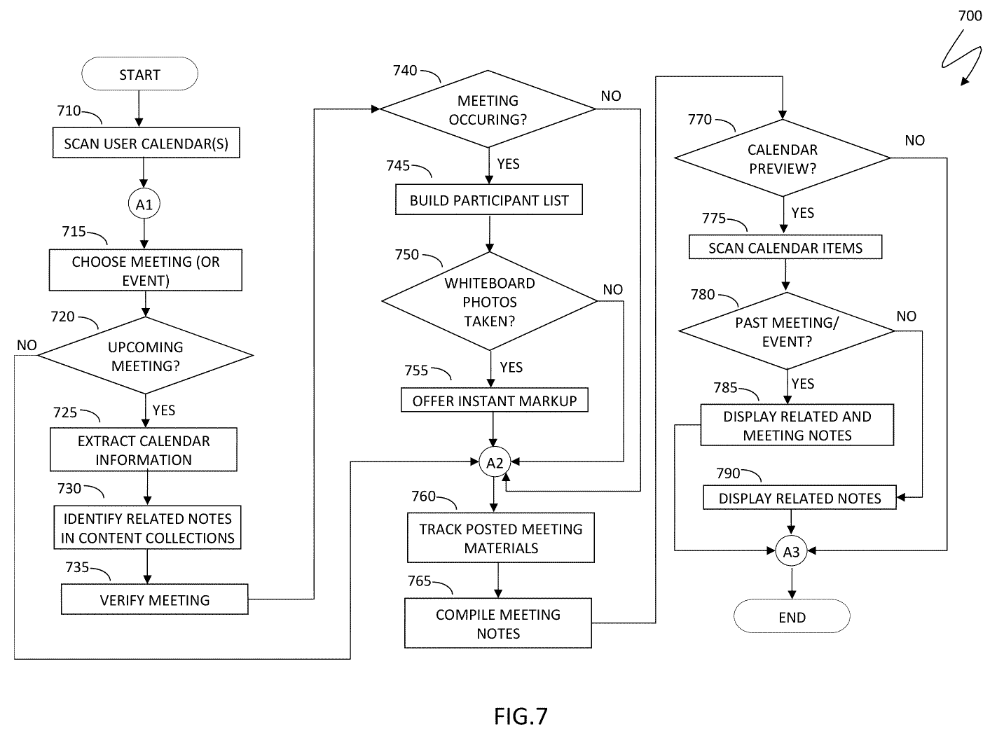

Referring to FIG. 7, a flow diagram 700 illustrates functioning of the system described herein. Processing starts at a step 710 where the system scans user calendar(s) to identify meetings and other relevant scheduled events. After the step 710, processing proceeds to a step 715, where the system chooses an individual meeting or event identified at the previous step 710. After the step 715, processing proceeds to a test step 720, where it is determined whether the selected meeting is an upcoming, future meeting. If so, processing proceeds to a step 725, where calendar information is extracted from the chosen event(s), such as a title, time, location, list of participants, agenda, etc., as explained elsewhere herein (see, for example, FIG. 1 and the accompanying text). After the step 725, processing proceeds to a step 730, where the system builds a set of related notes in content collections, as explained elsewhere herein (see, for example, FIG. 1 and the accompanying text). After the step 730, processing proceeds to a step 735, where an occurrence of the chosen meeting is verified, as explained in conjunction with FIG. 3 and elsewhere herein.

After the step 735, processing proceeds to a test step 740, where it is determined whether the chosen meeting is currently occurring, as explained in detail elsewhere herein (see, for example, FIG. 3 and the accompanying text). If so, processing proceeds to a step 745, where the system builds a list of actual meeting participants based on mobile location and connection information of the participants, as explained in detail elsewhere herein (see, for example, FIG. 3 and the accompanying text). After the step 745, processing proceeds to a test step 750, where it is determined whether whiteboard photographs or other photographs of instant (individual or shared) meeting notes are taken by actual meeting participants using smartphone cameras of the participants. If so, processing proceeds to a step 755, where the participants who take the photographs are offered an instant markup application with a hotspot feature, as explained elsewhere herein, in particular, in conjunction with FIG. 4 and the accompanying text.

If it is determined at the test step 750 that no whiteboard or other instant photographs of meeting materials are taken by meeting participants, control transfers to a step 760, where the system tracks posted meeting materials. The step 760 may also be reached from the test step 720 if the chosen meeting is a transpired rather than an upcoming meeting, as well as from the test step 740 if the chosen meeting is not currently underway. After the step 760, processing proceeds to a step 765, where the system compiles meeting notes from different sources, as explained in detail in conjunction with FIG. 5 and elsewhere herein. After the step 765, processing proceeds to a test step 770, where it is determined whether a current user needs a calendar preview enhanced with related and meeting notes, as explained in conjunction with FIG. 6 and elsewhere herein. If so, processing proceeds to a step 775; otherwise, processing is complete. At the step 775, the user scans calendar items (possibly on a large display, such as a smart TV set or a projection screen) and may choose meetings and other events to review, as explained in detail in conjunction with FIG. 6. After the step 775, processing proceeds to a test step 780, where it is determined whether the user is reviewing a past meeting or event. If so, processing proceeds to a step 785 where the system displays and allows further viewing of related notes and meeting notes. After the step 785, processing is complete. If it has been determined at the test step 780 that the user is reviewing an upcoming meeting or event, then processing proceeds to a step 790 where the system displays and allows further viewing of related notes. After the step 790, processing is complete.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions. The mobile device may be a cell phone, although other devices are also possible. The system described herein may be implemented with any type of electronic screen capable of being actuated by a touch screen, electromagnetic or other pen.

Note that the mobile device(s) may include software that is pre-loaded with the device, installed from an app store, installed from a desktop (after possibly being pre-loaded thereon), installed from media such as a CD, DVD, etc., and/or downloaded from a Web site. The mobile device may use an operating system such as iOS, Android OS, Windows Phone OS, Blackberry OS and mobile versions of Linux OS.

Software implementations of the system described herein may include executable code that is stored in a computer readable medium and executed by one or more processors, including one or more processors of a desktop computer. The desktop computer may receive input from a capturing device that may be connected to, part of, or otherwise in communication with the desktop computer. The desktop computer may include software that is pre-loaded with the device, installed from an app store, installed from media such as a CD, DVD, etc., and/or downloaded from a Web site. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of providing information to a participant of an upcoming meeting, comprising:
determining a list of participants of the meeting;
determining an agenda of the meeting;
analyzing a content collection to determine relevant portions of the collection that relate to the meeting; and
providing the relevant portions of the content collection to the participant prior to the meeting.

2. A method, according to claim 1, wherein providing the relevant portions includes causing the relevant portions to be displayed on smart glasses of the participant.

3. A method, according to claim 1, wherein providing the relevant portions includes causing the relevant portions to be sent to a mobile device of the participant.

4. A method, according to claim 3, wherein the mobile device uses an operating system selected from the group consisting of: iOS, Android OS, Windows Phone OS, Blackberry OS and mobile versions of Linux OS.

5. A method, according to claim 1, wherein the relevant portions of the content collection are provided automatically to the participant.

6. A method, according to claim 1, wherein the relevant portions of the content collection are provided automatically at a time around a start time of the upcoming meeting.

7. A method, according to claim 1, wherein the relevant portions of the content collection are provided automatically at a time around a start time of the upcoming meeting if the participant is at a location that is close enough to a location of the meeting to be able to attend the meeting.

8. A method, according to claim 1, wherein the relevant portions of the content collection are provided automatically if the participant had not previously accessed the relevant portions.

9. A method, according to claim 1, wherein analyzing a content collection to determine relevant portions includes determining similarities between the relevant portions and information about the upcoming meeting.

10. A method, according to claim 9, wherein determining similarities includes examining meeting time, location, participants, and context.

11. A method, according to claim 1, wherein items that relate to the meeting as well as items that relate to other previous meetings and items that relate to upcoming meetings are provided to a smart TV set.

12. A method, according to claim 11, wherein a calendar having the meetings and associated ones of the related items is provided to the smart TV set and a user scrolls through the calendar to see the meetings and the related notes.

13. Computer software, provided in a non-transitory computer-readable medium, that provides information to a participant of an upcoming meeting, the software comprising:
executable code that determines a list of participants of the meeting;
executable code that determines an agenda of the meeting;
executable code that analyzes a content collection to determine relevant portions of the collection that relate to the meeting; and
executable code that provides the relevant portions of the content collection to the participant prior to the meeting.

14. Computer software, according to claim 13, wherein executable code that provides the relevant portions causes the relevant portions to be displayed on smart glasses of the participant.

15. Computer software, according to claim 13, wherein executable code that provides the relevant portions causes the relevant portions to be sent to a mobile device of the participant.

16. Computer software, according to claim 15, wherein the mobile device uses an operating system selected from the group consisting of: iOS, Android OS, Windows Phone OS, Blackberry OS and mobile versions of Linux OS.

17. Computer software, according to claim 13, wherein the relevant portions of the content collection are provided automatically to the participant.

18. Computer software, according to claim 13, wherein the relevant portions of the content collection are provided automatically at a time around a start time of the upcoming meeting.

19. Computer software, according to claim 13, wherein the relevant portions of the content collection are provided automatically at a time around a start time of the upcoming meeting if the participant is at a location that is close enough to a location of the meeting to be able to attend the meeting.

20. Computer software, according to claim 13, wherein the relevant portions of the content collection are provided automatically if the participant had not previously accessed the relevant portions.

21. Computer software, according to claim 13, wherein executable code that analyzes a content collection to determine relevant portions determines similarities between the relevant portions and information about the upcoming meeting.

22. Computer software, according to claim 21, wherein determining similarities includes examining meeting time, location, participants, and context.

23. Computer software, according to claim 13, wherein items that relate to the meeting as well as items that relate to other previous meetings and items that relate to upcoming meetings are provided to a smart TV set.

24. Computer software, according to claim 23, wherein a calendar having the meetings and associated ones of the related items is provided to the smart TV set and a user scrolls through the calendar to see the meetings and the related notes.
